(19) United States
(12) Patent Application Publication
(10) Pub. No.: US 2013/0240449 A1
(43) Pub. Date: Sep. 19, 2013

(54) DEVICE FOR MATERIAL PURIFICATION

(71) Applicant: Lee Collier, Knoxville, TN (US)

(72) Inventor: Lee Collier, Knoxville, TN (US)

(73) Assignee: Advion Inc., Ithaca, NY (US)

(21) Appl. No.: 13/420,848

(22) Filed: Mar. 15, 2012

(51) Int. Cl. B01D 15/18

(52) U.S. Cl. 210/656; 210/198.2

(57) ABSTRACT

Systems and methods for purification of radiotracers and non-radioactive materials produced by both microfluidic, conventional, semi-automated and manual synthesis systems are described herein.

### TECHNICAL FIELD

Systems and methods for purification of radiotracers and non-radioactive materials are described herein.

### BACKGROUND

Single Photon Emission Computed Tomography (SPECT) and Positron Emission Tomography (PET) are molecular imaging technologies used for detection of disease. PET imaging systems create images based on the distribution of positron-emitting isotopes in the tissue of a patient. The isotopes are typically administered to a patient by injection of probe molecules that comprise a positron-emitting isotope (e.g., carbon-11, nitrogen-13, oxygen-15, or fluorine-18) covalently attached to a molecule or single photon emitting isotope (e.g. Technetium-99 m, Iodine-123 or Indium-111) which are either covalently attached or attached by complexation that are readily metabolized or localized in the body or that chemically binds to receptor sites within the body. For PET probes the short half-lives of the positron emitters require that synthesis, analysis and purification of the probes are completed rapidly.

Large-volume synthesis modules have been developed and used for the preparation of a number of radiopharmaceutical compounds and normally the purification of materials produced on these types of systems utilize semi-preparative purification systems and results in large volumes of the purified radiotracers.

### SUMMARY

Systems and methods for purification of compounds such as radiotracers and non-radioactive materials are described herein. More specifically, a fully automated purification of radioactive compounds for imaging (e.g., imaging by positron emission tomography (PET)) in a fast. efficient and compact manner is described herein. Embodiments relate to an automated, stand-alone, instrument for the rapid purification of radiopharmaceuticals utilizing smaller volumes of solvent, which can result in an increase in the radioactive concentration.

In some embodiments, the entire purification of both radiotracers and non-radioactive materials prepared on a microfluidic device, conventional automated systems, semi-automated and even manual prepared materials can be completed a period of time shorter than conventional preparative chromatography systems. In some additional embodiments, the system and method described herein can reduce the volume of solvent required to be used to purify a radiotracer produced on a synthesis device and increase the radioactive concentration of the resulting material.

In some aspects, a compound purification system includes a multi-position multi-port valve, a pre-concentration column having an input connected to a first port of the valve and an output connected to a second port of the valve, and a purification column having an input connected to a third port of the valve and an output. In a first position, the multi-port valve is configured to provide a fluid path between an input port and a waste port such that during use a liquid can flow from the input port, across the pre-concentration column and to the waste port and, in a second position, the multi-port valve is configured to provide a fluid path between the pre-concentration column and purification column such that during use a liquid can flow from the pre-concentration column to the purification column.

Embodiments can include one or more of the following.

The system can also include a product collection device connected to an output of the purification column.

The system can also include a second valve having a first port of the second valve configured to be connected to a water or buffer supply, a second port of the second valve configured to be connected to a device supplying a reaction product, a third port of the second valve connected to an input of the liquid storage device, a fourth port of the second valve connected to an output of the liquid storage device, and a fifth port providing an output from the second valve.

The system can also include tubing connecting the fifth port of the second valve to an input port on the multi-position multi-port valve.

The liquid storage device can be coiled PEEK, stainless steel or glass tubing.

The pre-concentration column can be a monolithic column.

The valve can be configured to direct the output flow between the waste port and a product vial connected to a fifth port of the valve.

The system can also include a pump configured to push or pull liquids onto the pre-concentration column.

The pre-concentration column further can include a guard column configured to protect the pre-concentration column.

The pre-concentration column can include an adsorbent material.

In some aspects, a method can include positioning a multiport valve in a first position, the multiport valve having ports connected to a pre-concentration column, a purification column, a waste receptacle, and a storage receptacle, while in the first position, pushing a liquid across the pre-concentration column to a waste receptacle such that impurities not trapped by the pre-concentration column flow to the waste receptacle, subsequent to pushing the liquid across the pre-concentration column, positioning the multiport valve in a second position that is different from the first position, and while in the second position, eluting liquid from the pre-concentration column onto the purification column.

Embodiments can include one or more of the following.

The method can also include pushing liquid from the purification column into the storage receptacle.

Pushing the liquid across the pre-concentration column can include pushing a small volume of less than 10 ml of liquid across the pre-concentration column.

Eluting liquid from the pre-concentration can include eluting liquid from the pre-concentration using less than 10 ml of solvent.

The pre-concentration column can be a monolithic column.

In some further aspects, a compound purification system can include a liquid storage device for storing a non-purified reaction product, a first multiport valve, a pre-concentration column, a purification column a second multiport valve. The first multiport valve can include a first port of the first multiport valve configured to be connected to a water or buffer supply, a second port of the first multiport valve configured to be connected to a device supplying a reaction product, a third port of the first multiport valve connected to an input of the liquid storage device, a fourth port of the first multiport valve connected to an output of the liquid storage device, and a fifth port providing an output from the first multiport valve. The second multiport valve can include a first port of the second multiport valve connected to the output from the first multiport valve and configured to receive the non-purified reaction product from the first multiport valve, a second port of the second multiport valve connected to an input of the pre-concentration column, a third port of the second multiport valve connected to an output of the pre-concentration column, and a fourth port of the second multiport valve connected to an input of the purification column.

Embodiments can include one or more of the following.

The system can also include a third multi-port valve comprising a first port of the third multi-port valve connected to an output of the purification column, a second port of the third multi-port valve connected to a waste collection device; and a third port of the third multi-port valve connected to a product collection device.

The second multiport valve can be a multi-position valve configured to provide, in a first position, a fluid path between the first port, the second port, the third port, and a waste port such that during use a liquid can flow from the first port, across the pre-concentration column and out the waste port and provide, in a second position, a fluid path between the second port, the third port, the fourth port, the fifth port, and an output port such that during use a liquid can flow from across the pre-concentration column and across the purification column.

The system can also include a product collection device connected to an output of the purification column.

The system can also include tubing connecting the second valve to an input port on the first valve.

The liquid storage device can be coiled PEEK, stainless steel or glass tubing.

The pre-concentration column can be a monolithic column.

The valve can be configured to direct the output flow between the waste port and a product vial connected to a fifth port of the valve.

The system can also include a pump configured to push or pull liquids onto the pre-concentration column.

The pre-concentration column further can include a guard column configured to protect the pre-concentration column.

The pre-concentration column can include an adsorbent material.

Other features and advantages of the invention will be apparent from the drawings, detailed description, and claims.

### DESCRIPTION OF DRAWINGS

FIG. 1 is a schematic diagram of a material purification system.

FIG. 2 is a flow chart of a material purification process.

FIGS. 3A-3B is a schematic diagram of a material purification system.

FIG. 4 is a schematic diagram of a material purification system.

FIGS. 5A-5L show exemplary plots.

### DETAILED DESCRIPTION

Methods and devices for an automated purification of compounds including those for imaging, such as by positron emission tomography (PET) are disclosed herein. In particular, the systems and methods described herein can enable the entire purification of both radiotracers and non-radioactive materials prepared on a microfluidic device, conventional automated systems, semi-automated and even manual prepared materials within a period of time shorter than conventional preparative chromatography systems. For example, the crude reaction product received by the system can be purified in a period of time of 10 minutes or less. Further, the systems and methods described herein are believed to enable a reduction in the volume of solvent required to purify a radiotracer and increase the radioactive concentration of the resulting material in comparison to conventional preparative chromatography systems. For example, the radio tracer can be purified using 12 ml of solvent or less and be typically obtained in less than 1 ml of solvent.

The systems described herein enable the entire purification cycle to be completed on a single device with within a period of time shorter than conventional radiochemistry purification systems (e.g., within a period of time of 15 min or less), exhibiting significantly higher plate counts (e.g., plate counts of 6000 or greater) and using significantly smaller amounts of solvents (using 12 ml of solvent or less).

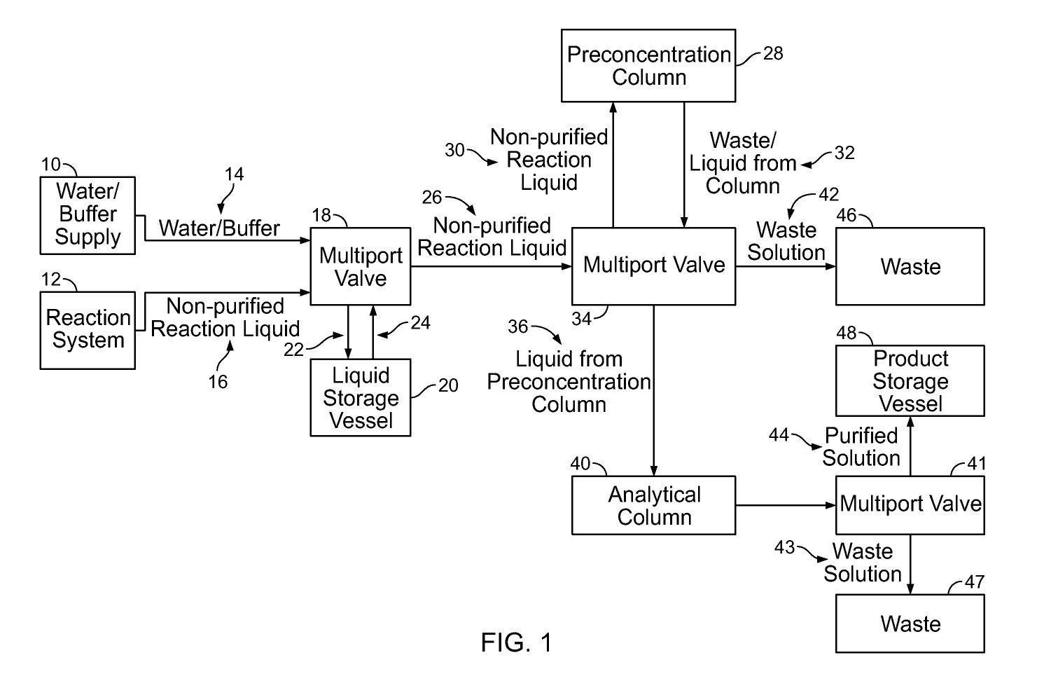

Referring to FIG. 1, a system for purification of compounds such as radiotracers and nonradioactive materials such as for imaging by positron emission tomography (PET) is shown. In some embodiments, the entire purification cycle can be completed on the system in an automated and stand-alone operation manner.

During use, a crude reaction product that includes the desired compound is received by the system from a reaction vessel 12, purified using a combination of a pre-concentration column 28 and an analytical column 40, and output into a product storage vessel 48. The system includes two multi-position multiport valves 18 and 34 configured to direct liquids through the system during the purification process. The system also includes a third valve 41 configured to direct the output from the purification column to either a waste receptacle 47 or a product storage vessel 48.

More particularly, a crude reaction liquid is generated by the reaction system 12 which is connected to a port on the multiport valve 18. A liquid storage vessel 20 is connected to another port of valve 18 and configured to receive and store the non-purified reaction liquid 16 from reaction system 12. For example, the non-purified liquid can be pushed from reaction system 12 to into a first valve on multiport valve 18 (as indicated by arrow 16) and out through a second valve (as indicated by arrow 22) into the liquid storage vessel 20. The non-purified liquid can be stored in the liquid storage vessel 20 until the purification process begins. In some examples, the liquid storage vessel 20 can be formed from a coiled tubing such as PEEK, stainless steel or glass tubing. The tubing can provide storage for a small volume of fluid such as between 1 and 10 ml of liquid.

The system also includes a water or buffer supply 10 connected to the multiport valve 18. In order to purify the liquid stored temporarily in liquid storage vessel 20, the liquid from liquid storage vessel 20 is pushed onto the second multiport valve 34 by water or buffer liquid 14 from the water buffer supply input 10. More particularly the valve of multiport valve 18 is opened to allow water or buffer from supply input to be directed through the multiport valve 18 and into the liquid storage vessel 20. As the liquid from the supply 10 fills the storage vessel, the liquid from the reaction system 12 which was stored in the liquid storage vessel 20 is pushed from the storage vessel 20 and into multiport valve 34. Once in multiport valve 34 the non-purified reaction liquid is directed onto a pre-concentration column 28, as indicated by arrow 30.

In general, the pre-concentration column can be any column or absorbent material that is configured for the concentration of the compound to be purified. Exemplary pre-concentration columns include monolithic columns such as those used in High performance liquid chromatography (HPLC). The basic methods of separation in HPLC rely on a mobile phase (water, organic solvents, etc.) being passed through a stationary phase (particulate silica packings, monoliths, etc.) in a closed environment (e.g., the monolithic column). Differences in reactivity among the compound of interest and the mobile and stationary phases distinguish compounds from one another in a series of adsorption and desorption phenomena. In some examples, the pre-concentration column is a monolithic column which allows for the reduction of the back pressure associated with the pre-concentration of the radiotracers. In another exemplary embodiment, the pre-concentration column may be any suitable column normally associated as a guard column for an HPLC column. In another exemplary embodiment, the pre-concentration column is a suitable ion exchange, gel filtration, gel permeation, or any affinity/bio-affinity column.

As the non-purified reaction liquid 30 is directed onto the pre-concentration column 28 the compounds of interest are collected on the pre-concentration column 28. Additional liquid and other waste matter (such as salts and impurities) are directed through the pre-concentration column 28 and into a waste receptacle 46 (e.g., a drain or a storage container). Thus, the pre-concentration column 28 traps the substances of interest from the non-purified reaction liquid. After a desired amount of the non-purified reaction liquid is directed across the pre-concentration column 28, a solvent or other liquid is directed across the pre-concentration column 28 to push the substances trapped by the monolithic column 28 onto the analytical column 40. The analytical column separates the components of the mixture received from the pre-concentration column for further use (and is thus a form of purification). Thus, in this example, the analytical column is used in a preparative chromatography process to purify sufficient quantities of a substance for further use, rather than to provide analysis of the compounds included in the liquid.

More particularly, an output of the pre-concentration column 28 is connected to an input of the analytical column 40 by a connection in the multiport valve 34. This connection allows liquid from the pre-concentration column 28 (as indicated by arrow 32) to be directed across the multiport valve 34 and on to the analytical column 40 (as indicated by arrow 36). Further purification of the liquid from the pre-concentration column 28 occurs on the analytical column 40. For example, the substances of interest (e.g., the radiotracers and/or radio isotopes) are sometimes referred to as the immobilized phase which is a stationary phase that is immobilized on the support particles of the analytical column. Thus, the substance of interest is retained within the analytical column 40 as the liquid from the pre-concentration column 28 passes through the analytical column 40. During this process, the output of the analytical column is connected to a waste receptacle 47 (e.g., a drain or a storage container) by a valve 41 (as indicated by arrow 43). After purification is complete, the materials trapped on the analytical column 40 are directed from (e.g., eluted from) analytical column 40 through valve 41 and into a product storage vessel 48 (as indicated by arrow 44). As such in the system of FIG. 1, a single system (e.g., a closed liquid path) allows non-purified reaction liquid from reaction system 12 to be purified and stored in the product storage vessel 48. In the system, the output of the pre-concentration column 28 is connected to a waste line in a first position of a multiport valve 34 and to the input of an analytical column 40 through a multiport valve in a second position of the multiport valve 34.

The system shown in FIG. 1 is believed to provide various advantages in purification of the reaction product. In some examples, the system allows purification of a compound in a small volume (e.g., 1 ml or less) of liquid or solvent. Which can allow the purified reaction product to be used directly (e.g., directly administered to a human or animal) without requiring additional post-processing steps such as evaporation of solvent. In contrast, if a large volume of ethanol or other solvent is used to purify a compound, the solvent needs to be removed prior to use of the compound which can add additional time and processing steps to the purification of the compound. In some embodiments, the use of smaller volumes of solvent to purify the compound results in an increase in the radioactive concentration of the purified materials. In some additional examples, the system shown in FIG. 1 can provide a shorter processing time to purify the compound. For example, when purifying isotopes with a short half-life (e.g., a half-life of 25 minutes or less, the total processing time can be critical because the concentration of the isotope is reduced as the processing time is increased. Thus, having a single system that includes both the pre-concentration column 28 and the analytical column 40 allowing liquid to be pushed directly from the reaction system through the pre-concentration column 28 and onto the analytical column 40 to purify the liquid provides the benefit of reducing the processing time required to purify the compound from the reaction system.

The valves 18, 34, and 41 can be controlled and moved to different positions by any known manner. For example, the valves can be controlled by pneumatic actuators. In some additional examples the valves can be controlled by a solenoid. In some additional examples, the valves can be electronically controlled by a computing device connected to the valves.

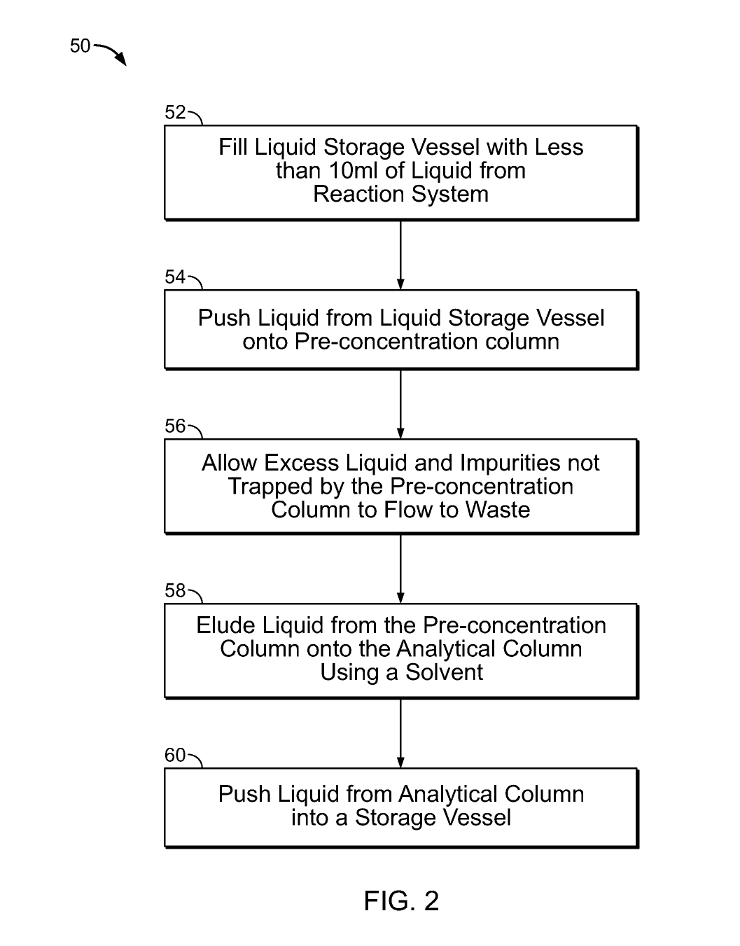

Referring to FIG. 2, a process 50 for purification of a reaction product using a pre-concentration column and analytical column connected to one another by a multiport valve is shown. As shown in block 52, process 50 includes filling a liquid storage vessel with a small volume of liquid from a reaction system. For example the total volume of non-purified reaction liquid can be 10 mL or less. As shown in block 54, the liquid from liquid storage vessel is pushed onto a pre-concentration column. As the liquid is pushed across the pre-concentration column, excess liquid and impurities that are not trapped by the pre-concentration column flow to a waste receptacle as shown in block 56. After the non-purified reaction liquid is pushed across the pre-concentration column, the compounds trapped on the pre-concentration column are eluted onto an analytical column using a solvent as shown in block 58. Finally, the compounds trapped by the analytical column, which provide a purified form of the initial reaction product, are pushed into a storage vessel. For example, the compounds can be eluted from the analytical column using a small volume of solvent. While not shown in FIG. 2, additional liquid or solvent can be pushed through the system to cleanse and decontaminate the system after a purification cycle is complete. Additionally, air or other gases such as nitrogen can be pushed through the delivery system to remove any remaining liquids or solvents from the system and minimize losses of desired materials which are contained in the delivery system.

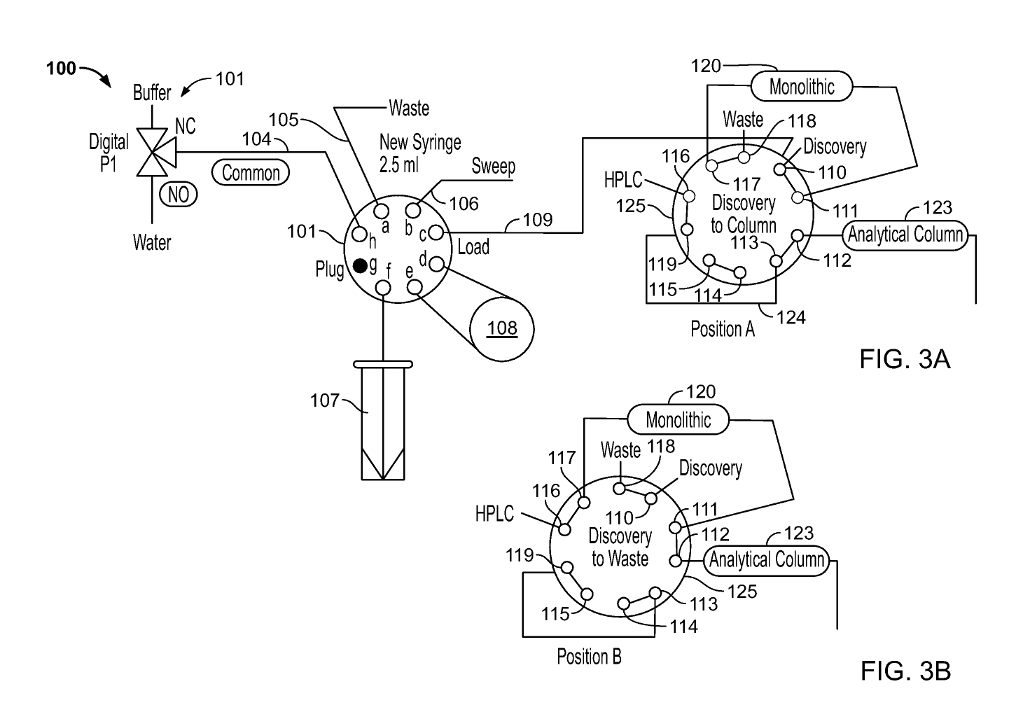

FIGS. 3A and 3B show an exemplary embodiment of the purification system. As described above, the purification system includes both a pre-concentration column 120, e.g. a monolithic column, and an analytical column 123. The multiport valve 125 is a two position, ten port valve. In position A, a first set of ports are connected to one another in the multiport valve 125, this connects the input to the pre-concentration column to the valve 101, which is used to transfer the non-purified reaction mixture to the pre-concentration column and the output of the pre-concentration column is connected to the waste. The waste will contain any material which was not retained by the pre-concentration column. In this position the analytical column is connected to the HPLC and is being prepared for the purification while the pre-concentration occurs. In position B a second set of ports, which is different than the first set of ports, are connected to one another, and in this position the HPLC is connected to the pre-concentration column which is in turn connected to the analytical column. These two positions and the associated connections are shown in FIGS. 3A and 3B, respectively. Thus, by changing the position of multiport valve 125 from position A to position B the connections in the multiport valve are modified as indicated by the solid lines in the valve shown in the Figures. An exemplary multiport valve is part number MXP7960-000 as available from Analytical Sales & Service, Inc.

The system also includes a second multiport valve 101 which is used to select a liquid to direct into valve 125. Valve 101 is connected to various inputs such as a water/buffer input 101 and an input from a reaction system 107. Additionally, valve 101 is connected to a storage vessel which provides storage of a reaction product prior to purification.

During use, the multiport valve 125 is initially positioned in position A. In position A, liquid from multiport valve 101 (e.g., non-purified reaction liquid), is received on port 110 of multipart valve 125. Port 110 is connected via a liquid path to port 111 and port Ill is connected to an input 121 of the monolithic column 120. The output of the monolithic column 120 (output 122) is connected to port 117 of multiport valve 125. Port 117 of multiport valve 125 is connected to port 118 and port 118 is connected to a waste container. Thus, during use, non-purified reaction liquid can be pushed from multiport valve 101 directly onto monolithic column 120 (e.g., through the connection of ports 110 and 111) and excess liquid and compounds not trapped my monolithic column 120 can be directly expelled to a waste container through port 118.

After a desired amount of non-purified reaction liquid has been pushed across monolithic column 120, multiport valve 125 is changed from position A to position B. In position B the internal connections of multiport valve 125 are modified from those in position A. In position B, the input from multiport valve 101 at port 110, is directly connected to the waste receptacle on port 118. In position B the HPLC is in line with both the trapping column, e.g. monolithic column 120, and the analytical column 123 allowing further purification of the compound on the analytical column 123. Liquid from HPLC is directed onto the monolithic column 120 through port 116. Port 116 is connected to port 117 such that the liquid received a port 116 is pushed onto monolithic column 120. The output of monolithic column 120 is connected to port 111 which is connected through valve 125 to port 112 which is connected to an input of the analytical column 123. Thus, in position B, the HPLC pump flushes out or elutes off compounds trapped on the monolithic column 120 onto the analytical column 123.

In order to purify a liquid using the system shown in FIG. 3, first the 10 way valve 125 is placed into position B. Subsequently, the loop (e.g., the liquid storage vessel which, in one example can be a loop or coil of PEEK tubing) is filled with water or buffer (e.g., with up to 5 ml of Water or Buffer). Subsequently, valve 101 is placed to push water/buffer from port E onto the loop with materials and excess volume flowing out waste on the 10 Way Valve 125. The 10 way valve 125 is then switched to Position A and the HPLC pump is started. Subsequently, the reaction vessel is diluted with sufficient water to reduce the organic concentration to typically <10%. Then, the volume is loaded onto the loop (e.g., pushed into the liquid storage vessel) and then is pushed onto the monolithic column, the loop may be refilled multiple times to pass all of the solution from the reaction vessel onto the monolithic column. Upon completion of the loading the material onto the trapping column 120 the loop is filled with a volume of water, and this is pushed across the trapping column to remove salts and polar materials. Subsequently, the 10 Way valve 125 is switched to Position A and the HPLC pump is started. This flushes the monolithic column with water to remove more organic solvent. Then, 10 Way Valve is switched to Position B, HPLC pump flushes out the Monolithic column to the Analytical column (e.g., using step or gradient stalling at mainly water and step up to required organic to perform separation). Finally, the Monolithic column and Analytical column are re-equilibrated to starting conditions.

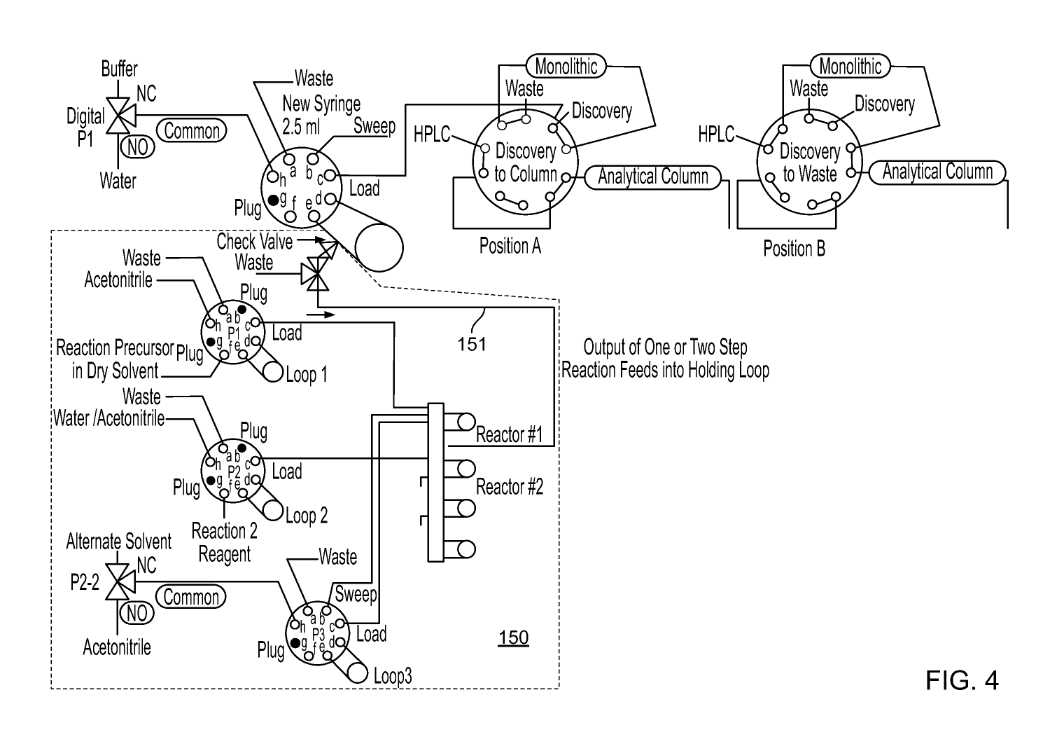

Referring to FIG. 4, another exemplary system for purification of a compound is shown. The system in FIG. 4 allows direct dilution of the reaction product as the reaction product is being input into the purification system. In the system of FIG. 4, a reaction system 150 is connected to an input (e.g., port e) on valve 101. System 150 includes two reactors, reactor #1 and reactor #2, however any number of reactors could be connected via an output line 151 to an input of multi-port valve 101. The crude reaction product is received directly at port E and can be diluted by input of water or other solvent through the input connected to port H of valve 101. Because port H is connected to port E through the valve 101, by modifying the flow of liquid into port E from the reaction system 150 and the flow of liquid into port H, dilution of the crude reaction product can be achieved as the reaction product is being input into the purification system. For example, water/Buffer in a Syringe (e.g., attached to port H) will be used to dilute the organic coming from the reaction system to ˜10-20% organic, or a valve that allows for the efficient trapping of the desired material on the preconcentration column.

In some additional embodiments, the purification system is further adapted to communicate with a network for fluid and gas delivery and removal. In one embodiment, one or more syringes are used for delivery of a fluid or gas. In one embodiment, the syringes are located below one or more vials with liquid contents to effect efficient delivery of liquids to the system. In another embodiment, the syringes are used for delivery of gas to the system. In a different embodiment, the network is adapted to operate with at least one of a pre-filled individual vial (the vial may contain a suitable dilution fluid such as a buffer which is used to adjust the quality of the solution added to make it to a form with is trapped on the pre-concentration column in a more efficient manner) and a pre-packaged cartridge, these cartridges are capable of operating at HPLC pressures and can be made from suitable polymer, metal or a glass lined metal or polymer to maintain the integrity of the chemicals contained in the cartridge, the cartridge is used in place of the pre-concentration trap and can be used as a single use or multiple purification steps. In one embodiment, the cartridge contains a pre-measured amount of dilutent sufficient for single use with the system. In a different embodiment, a controlled delivery of liquids is affected by use of a syringe pump.

According to another embodiment, solvent evaporation and vapor removal are effected by flowing gas which is controlled by a rotometer, needle valve or a mass flow controller obtained from a source such as a gas bottle or tank through a “T” connected in line with the delivery line to the product vial and may be suitable filtered to render the gas as sterile if required over the solution inside the product vial (e.g., after the product is received from the analytical column). In one embodiment the gas is Nitrogen. According to a different embodiment, removal of the solvent is effected by heating the gas used for evaporation and/or the application of a vacuum.

According to another embodiment, the device is configured to operate in a batch mode.

In one embodiment, the device is configured to operate in combination with a stopped flow-through mode, where the product to be purified is collected into a vial and suitable manipulations such as adjustment of the pH or organic concentration are made to the vial prior to effecting the purification, while in a different embodiment; the device is configured to operate in a sampling-flow through mode. In this mode, the adjustments are made using a fluid flow of the adjusting fluid which is used to adjust the properties of the fluid such as pH or organic contents etc., in a continuous flow mode. In a different embodiment of the present invention the localized shielding is effected for at least the pre-concentration and analytical column which allows the purification to take place without the need for localization in a hotcell or other large shielded enclosure.

In another embodiment, the controller comprises a programmable logic controller and a user interface. In one embodiment, the user interface is configured to effect at least one of a manual, semi-automated and a full automatic operation of the device.

According to another embodiment, the device further comprises one or more internal filters which are located prior to addition of the fluid to container 107 in FIG. 3A or in line 151 in FIG. 4 for removal of particulates prior to loading on the system from the production device. In another embodiment, the localized shielding around the unit as a whole such that the units may be operated outside of a hotcell or other large shielded device and prevents user exposure to radiation in multiple purification runs conducted by the user.

According to another embodiment, the device may automatically dilute, by the use of a suitable dilution fluid contained in a sterile syringe or obtained from a sterile vial into a sterile syringe controlled by a suitable syringe drive, the final collected volume with a biocompatible fluid.

A different aspect of the present invention involves a program code embodied on a computer-readable medium, the program code comprising instructions for causing a controller to implement a method for the purification of a radiolabeled compound using a microfluidic system, fully automated conventional system, a semi-automated or manual system.

In addition, the methods and devices in accordance with the various embodiments of the present invention may provide the following additional features and benefits: The device can be capable of conducting multiple purification runs without user exposure to radiation (including purification of different products). In some examples, localized shielding can protect users and electronics at the same time. In some examples, automated product recognition and isolation can be provided. In some examples, the system can be configured for tabletop operation—no exhaust handling such as a fume hood. In some examples, the system can include an automated organic solvent removal system. In some examples, the entire process can be performed automatically with a single command.

In some examples, the systems and methods described herein can be used to purify pharmaceuticals radiolabeled with F-18 including 2-deoxy-2-[F-18]-fluoro-D-glucose (.sup.18F-FDG), 3′-deoxy-3′-[F-18]-fluorothymidine(.sup.18F-FLT), 9-[4-[F-18]fluoro-3-(hydroxymethyl)butyl]guanine (.sup.18F-FHBG), 9-[(3-[F-18]fluoro-1-hydroxy-2-propoxy)methyl]guanine (.sup.18F-FHPG), 3-(2′-[F-18]fluoroethyl)spiperone(.sup.18F-FESP), 4-[F-18]fluoro-N-(2-(1-(2-methoxyphenyl)-1-piperazinyl)ethyl)-N-2-pyridin-yl-benzamide(.sup.18F-p-MPPF), 2-[F-18]fluoro-.alpha.-methyltyrosine, [F-18]fluoromisonidazole(.sup.18F-FMISO), 5-[F-18]fluoro-2′-deoxyuridine (18F-FdUrd) and other radiolabeled compounds such as .sup.11C-raclopride and .sup.11C-methionine.

### EXAMPLE

A system was set-up as shown in the diagram shown in FIG. 4. The default position of the 10 port 2-position valve is Position B. The results below are the outcomes of some studies that were performed with cold SFB. SFB is a group which is used to label peptides, proteins, and antibodies.

The initial test was performed by using the following set-up;

1) Syringe on Pump is a 2.5 ml syringe,

2) Tubing is set up on the Pump in a similar manner as that used by a normal set-up,

3) Loop size is 1.74 mL (this storage loop will be used like the rest of the system,

4) The monolithic column used was a Phenomenex Onyx Monolithic C18, 50×4.6 mm,

5) No Analytical column was connected, but the monolithic column after trapping was moved to the Agilent 1200 and attached in between the injector and the existing analytical column.

The monolithic column was prepared by first washing with 90% acetonitrile/water then preparing the column with 100% Water.

A solution of 12.1 mg of SFB standard was dissolved in 4 ml of 20% Acetonitrile/Water giving a final solution of 3.025 mg/ml. The 1.74 ml loop was loaded with this solution (5.26 mg of SFB) and this solution was then pushed through the monolithic column at 1 ml/min, using 2.5 ml of Water in the syringe and pushing the water on to the loop through Port E.

The HPLC system used included a Phenomenex C-18(2), 5um, Luna 4.6×250 mm column eluted with a 50% Acetontrile/1% Acetic Acid mobile phase at 1 ml/min, for 0-8 minutes then a linear gradient from 8-12 to a concentration of 90% Acetonitrile : 1% Acetic Acid.

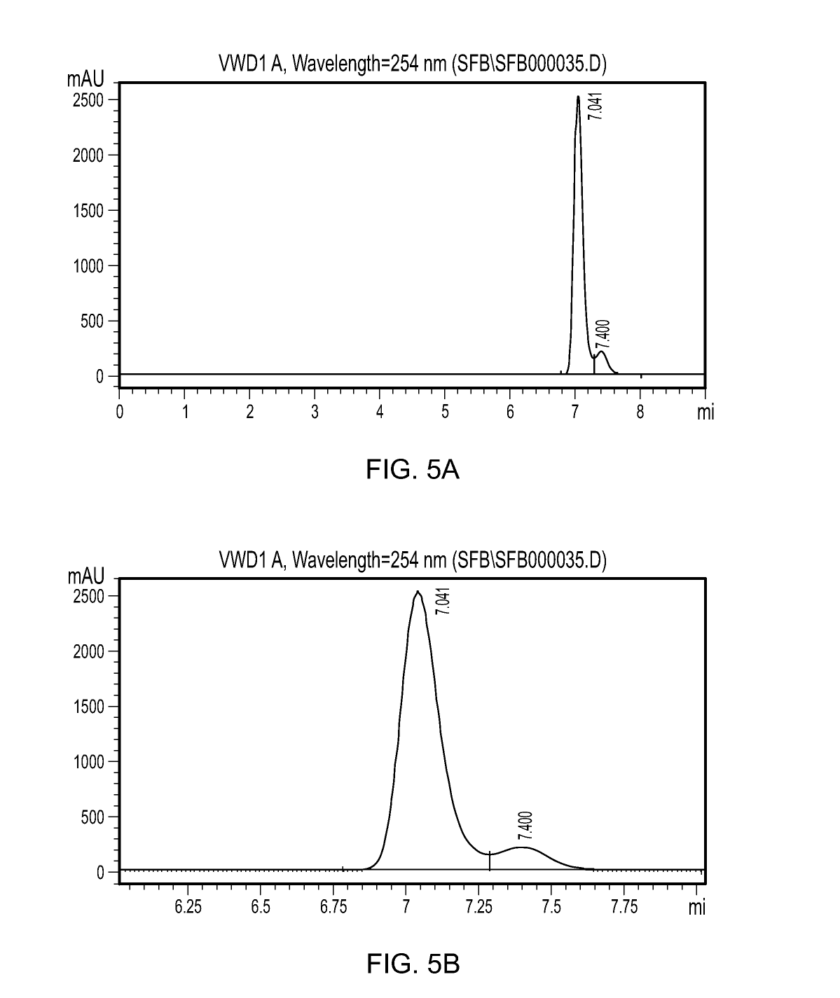

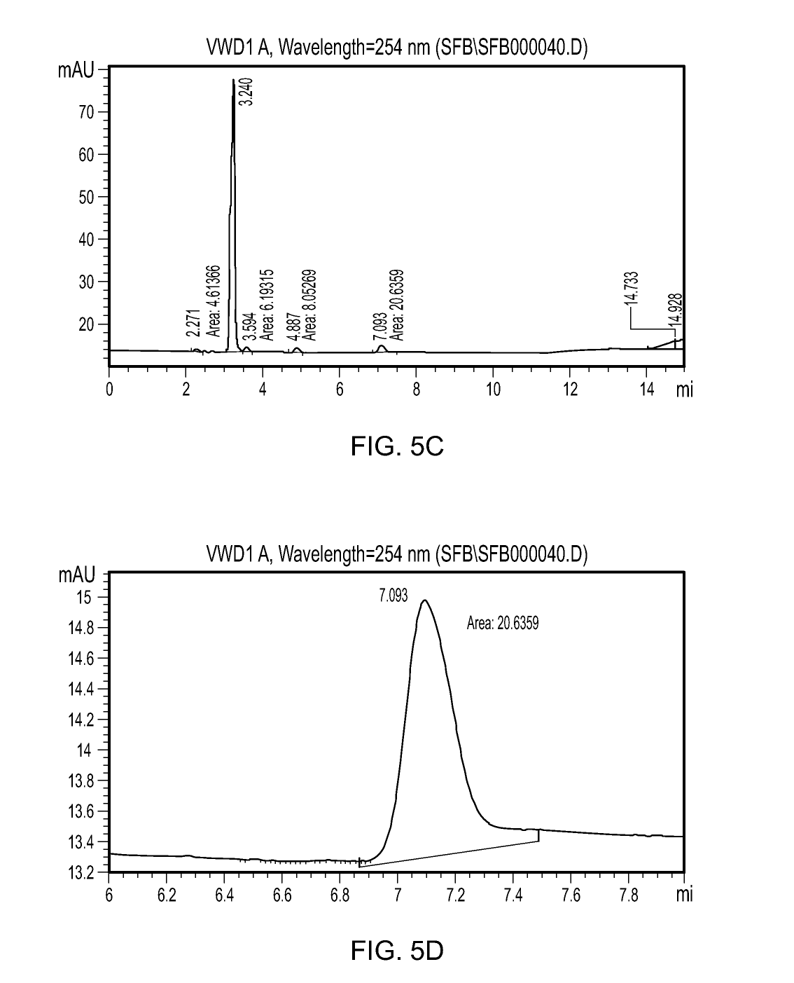

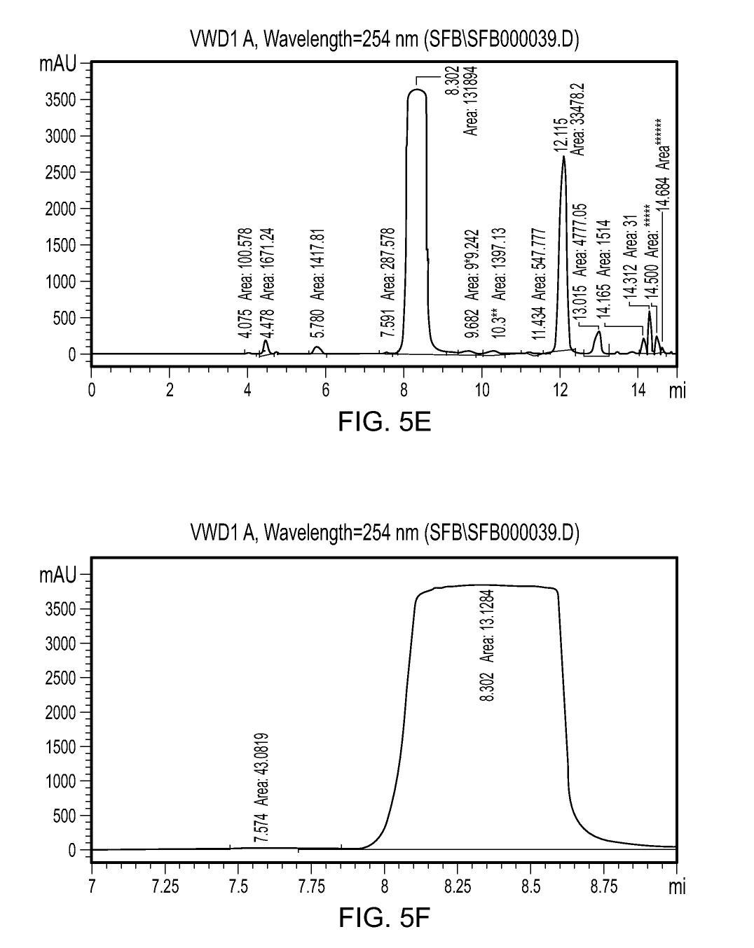

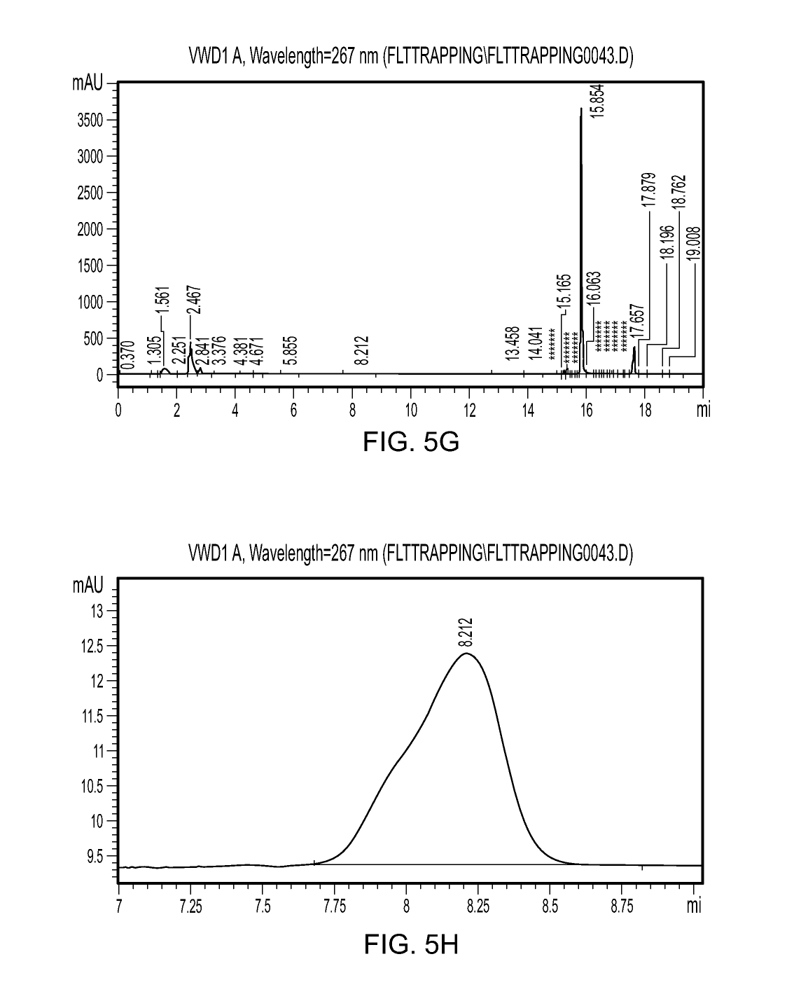

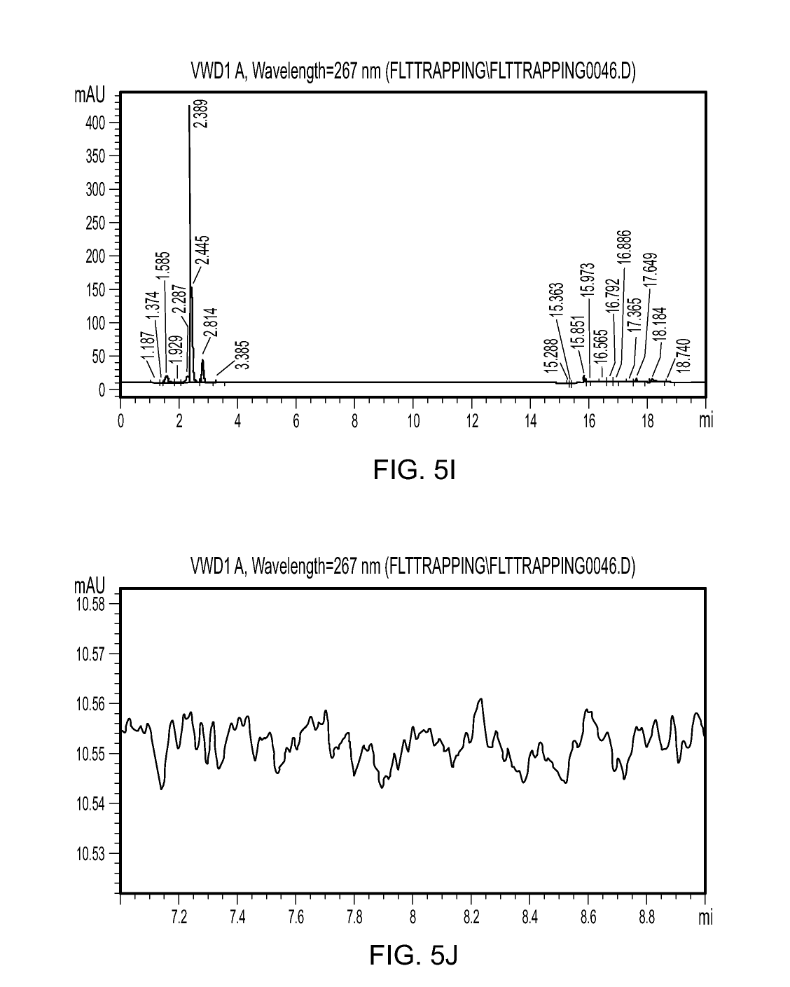

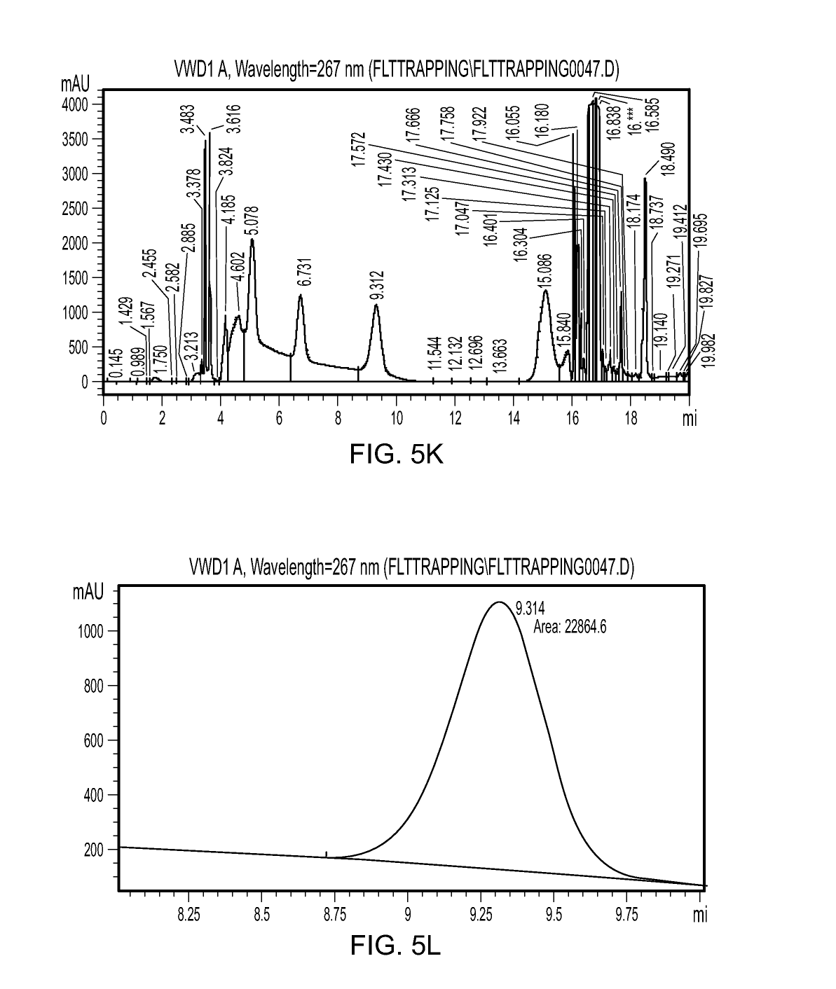

FIG. 5A shows a plot of the HPLC trace obtained from a 20 ul injection of the solution prior to the application to the monolithic column. The plot in FIG. 5A shows the original solution of 12.1 mg/4 ml in 20% ACN/water. FIG. 5B shows an expanded Plot showing the area around the actual peak. The minor impurity at 7.4 is a minor degradation of the SFB standard. The area of the desired SFB peak was 3247.88 mAu*s.

The solution which was obtained after the solution was passed through the monolithic column was then injected to determine the breakthrough of the SIB through the monolithic column. FIGS. 5C and 5D show plots of a 20 ul injection of the solution, e.g., a plot of water from the trapping onto the monolithic column.

The resulting area was 20.6359 mAu*s. This indicates that the system has <0.7% breakthrough of the desired compound.

The monolithic column with the material trapped on it was removed from the system and placed between the HPLC injector and the Analytical column on the Agilent 1200 HPLC system and a blank injection was made so that the HPLC system would be triggered and the material trapped on the monolithic column would be eluted. The retention time will be slightly delayed by the need to elute the material off the monolithic column prior to being injected onto the analytical column.

FIGS. 5E and 5F show plots of the result of the material trapped on the monolithic column. The peak saturated the detector so the peak shape looks poor, the peaks near the desired peak has a plate count of ˜5000.

Thus, as shown in the example provided in FIGS. 5A-5E, the system provides the ability to trap virtually all of the material applied to the monolithic column. Additionally, the normal semi-prep purification of this material results in a volume of 8-10 mls which needs to be evaporated. The use of the analytical column results in a total volume of ˜0.7 ml so only ˜350 ul of Acetonitrile needs be removed by evaporation and dilute with a small volume of Phosphate Buffered saline to bring the pH to between 4.5-8. We needed to add a gas supply to flush out the product delivery line since the holdup volume of the product line is ˜200 ul. The resolution of the column is high enough that the purity of the final product will be higher than that normally obtained using a standard semi-prep HPLC column.

In the example above, the system was set-up as for SFB. To test the trapping of the FLT from a typical radiosynthesis 20 mg of the FLT precursor (3-NBoc-5′-O-dimethoxytrityl-3′-O-nosyl-thymidine) in 0.6 ml of Acetonitrile was placed into the 5 ml V-Vial used for the hydrolysis of FLT and the normal hydrolysis macro was run. All solution colors normally seen in the hydrolysis were observed. The final solution (˜3.5 ml) was spiked with 50 ul of a 0.1 mg/ml solution of FLT dissolved in 10% Ethanol/water.

The initial solution obtained from the hydrolysis was injected on the standard Analytical HPLC system used for the QC of FLT and is shown in FIGS. 5G and 5H.

Initial Solution of FLT obtained from the simulated hydrolysis and spiked with FLT standard. The peak shape of the FLT standard was distorted by the presence of the salts used to neutralize the acid used in the hydrolysis of the labeled FLT synthesis. The area of this peak was 69.4 mAU*s. and has a symmetry of 1.7

The solution that was collected off the monolithic column trapping of the solution was injected onto the analytical system and the resulting chromatogram and expanded chromatogram in the FLT region is shown in FIGS. 5I and 5J. As can be seen in the chromatograms shown in FIGS. 5I and 5J, the polar impurities are not retained by the monolithic column. This will allow us to remove the salts, unreacted fluoride and polar radioactive degradation products from the material which will be placed on the analytical column.

As can be seen above, the FLT has been fully retained by the monolithic column.

The monolithic column was then attached in front of the FLT analytical HPLC column (Phenomenex Synergi 4u Hydro-RP 80 A, 4.6×150 mm) and the sample was eluted using the FLT mobile phase of 10% Acetonitrile/Water (0-12 minutes) then a linear gradient to 90% Acetonitrile/Water (12-20). The chromatogram obtained from the elution of the material from the monolithic column is shown in FIGS. 5K and 5L. The FLT peak was eluted at approximately 1 minute later due to the addition of the monolithic column, the peak at 9.3′ was collected for injection on the analytical system for confirmation of identity.

In this example, the plate count is 3726 and the Symmetry is 1.089, so the removal of the salts has improved the peak shape significantly and the total volume of the peak is <1 ml. This will result in an increase of the radioactive concentration of approximately 5× and a reduction in the solvent used for the purification from ˜80 ml to ˜10 ml.

As shown from the example above, the system provides the ability to trap virtually all of the material applied to the monolithic column. Further, the normal semi-prep purification of this material results in a volume of 5-6 mls. The use of the analytical column results in a total volume of ˜0.9. Additionally, the resolution of the column is high enough that the purity of the final product will be higher than that normally obtained since there is a close peak using the normal semiprep column and typically some of the radioactive peak is discarded to eliminate the cold impurity peak. Further, for animal studies, the front and back part of the peak is not normally collected, so that only the central part on either side of the peak is collected, Which results in some loss of activity, if the same thing is done on the analytical system then we will obtain an even higher radioactive concentration. Additionally, the analytical solvent of 10% acetonitrile/water can be replaced with 10% ethanol/water or the normal 8% ethanol/Phosphate buffered saline and this will eliminate the need to remove the acetonitrile.

Many other implementations of the invention other than those described above are within the invention, which is defined by the following claims.

What is claimed is:

1. A compound purification system, comprising:
a liquid storage device for storing a non-purified reaction product;
a first multiport valve having:
a first port of the first multiport valve configured to be connected to a water or buffer supply,
a second port of the first multiport valve configured to be connected to a device supplying a reaction product;
a third port of the first multiport valve connected to an input of the liquid storage device,
a fourth port of the first multiport valve connected to an output of the liquid storage device; and
a fifth port providing an output from the first multiport valve;
a pre-concentration column;
a purification column,
a second multiport valve having:
a first port of the second multiport valve connected to the output from the first multiport valve and configured to receive the non-purified reaction product from the first multiport valve;
a second port of the second multiport valve connected to an input of the pre-concentration column;
a third port of the second multiport valve connected to an output of the pre-concentration column; and
a fourth port of the second multiport valve connected to an input of the purification column.

2. The system of claim 1, further comprising a third multi-port valve comprising a first port of the third multi-port valve connected to an output of the purification column, a second port of the third multi-port valve connected to a waste collection device; and a third port of the third multi-port valve connected to a product collection device.

3. The system of claim 1, wherein the second multiport comprises a multi-position valve configured to:
provide, in a first position, a fluid path between the first port, the second port, the third port, and a waste port such that during use a liquid can flow from the first port, across the pre-concentration column and out the waste port; and
provide, in a second position, a fluid path between the second port, the third port, the fourth port, the fifth port, and an output port such that during use a liquid can flow from across the pre-concentration column and across the purification column.

4. A compound purification system, comprising:
a multi-position multi-port valve;
a pre-concentration column having an input connected to a first port of the valve and an output connected to a second port of the valve;
a purification column having an input connected to a third port of the valve and an output;
wherein, in a first position, the multi-port valve is configured to provide a fluid path between an input port and a waste port such that during use a liquid can flow from the input port, across the pre-concentration column and to the waste port and, in a second position. the multi-port valve is configured to provide a fluid path between the pre-concentration column and purification column such that during use a liquid can flow from the pre-concentration column to the purification column.

5. The system of claim 4, further comprising a product collection device connected to an output of the purification column.

6. The system of claim 4, further comprising
a second valve having:
a first port of the second valve configured to be connected to a water or buffer supply,
a second port of the second valve configured to be connected to a device supplying a reaction product;
a third port of the second valve connected to an input of the liquid storage device,
a fourth port of the second valve connected to an output of the liquid storage device; and
a fifth port providing an output from the second valve; and
tubing connecting the fifth port of the second valve to an input port on the multi-position multi-port valve.

7. The system of claim 6, wherein the liquid storage device comprises coiled PEEK, stainless steel or glass tubing.

8. The system of claim 4, wherein the pre-concentration column comprises a monolithic column.

9. The system of claim 4, wherein the valve is configured to direct the output flow between the waste port and a product vial connected to a fifth port of the valve.

10. The system of claim 4, further comprising a pump configured to push or pull liquids onto the pre-concentration column.

11. The system of claim 4, wherein the pre-concentration column further comprises a guard column configured to protect the pre-concentration column.

12. The system of claim 4, wherein the pre-concentration column comprises an adsorbent material.

13. A method comprising:
positioning a multiport valve in a first position, the multiport valve having ports connected to a pre-concentration column, a purification column, a waste receptacle, and a storage receptacle;
while in the first position, pushing a liquid across the pre-concentration column to a waste receptacle such that impurities not trapped by the pre-concentration column flow to the waste receptacle;
subsequent to pushing the liquid across the pre-concentration column, positioning the multiport valve in a second position that is different from the first position;
while in the second position, eluting liquid from the pre-concentration column onto the purification column.

14. The method of claim 13, further comprising pushing liquid from the purification column into the storage receptacle.

15. The method of claim 13, wherein pushing the liquid across the pre-concentration column comprises pushing a small volume of less than 10 ml of liquid across the pre-concentration column.

16. The method of claim 13, wherein eluting liquid from the pre-concentration comprises eluting liquid from the pre-concentration using less than 10 ml of solvent.

17. The method of claim 13, wherein the pre-concentration column comprises a monolithic column.
